(19) United States
(12) Patent Application Publication
(10) Pub. No.: US 2009/0002506 A1
(43) Pub. Date: Jan. 1, 2009

(54) IMAGE CAPTURING APPARATUS AND IMAGE CAPTURING METHOD

(75) Inventor: Michitomo KODA, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Sony Corporation, Tokyo (JP)

(21) Appl. No.: 12/124,427

(22) Filed: May 21, 2008

(30) Foreign Application Priority Data
Jun. 28, 2007 (JP) 2007-170515

(51) Int. Cl. H04N 5/225

(52) U.S. Cl. 348/220.1; 348/E05.024

(57) ABSTRACT

An image capturing apparatus includes: a captured still image data generating section that converts captured light into an electrical signal and generates captured still image data from the electrical signal; a recording section that records the captured still image data onto a recording medium; a free-capacity recognizing section that recognizes a free capacity on the recording medium; a prescribed-maximum-possible-record-count calculating section that calculates a prescribed maximum possible record count according to the free capacity; and a parameter determining section that determines a parameter set on the captured still image data generating section to adjust a data size of the captured still image data. The parameter determining section determines the parameter so that the captured still image data is adjusted to a data size that allows recording of captured still image data equal to the prescribed maximum possible record onto the recording medium while making maximum use of the free capacity.

### CROSS REFERENCES TO RELATED APPLICATIONS

The present invention contains subject matter related to Japanese Patent Application JP 2007-170515 filed in the Japanese Patent Office on Jun. 28, 2007, the entire contents of which are incorporated herein by reference.

### BACKGROUND OF THE INVENTION

1. Field of the Invention

The present invention relates to an image capturing apparatus that can record a captured image obtained by image capture onto a recording medium, and an image capturing method for use in this image capturing apparatus.

2. Description of the Related Art

As a type of recording media for mobile equipment or the like, a recording medium (recording medium apparatus) generally called a memory card has come into widespread use. This memory card includes, for example, a flash memory as a recording medium, and has a card-shaped outward appearance conforming to a memory card standard.

Further, such a memory card is available for sale and offer in several different recording capacities under a single media standard. That is, from the user's perspective, the user is given a selection of memory cards to choose from according to the capacity. When acquiring a memory card by purchase or the like, the user chooses one having a recording capacity that is considered most appropriate for his/her own intended use or the like.

For example, when purchasing a memory card with its use as recording media for a digital still camera in mind, the user is to choose a memory card capacity by taking into account the data size per one still image, which is determined in accordance with the picture size the user wants to set for still image data he/she is going to capture and record, and the number of still image pictures the user wants to record on a single memory card.

### SUMMARY OF THE INVENTION

In view of the circumstances mentioned above, in some of the memory cards available on the market, the number of pictures that can be captured and recorded under the condition of a certain set reference picture size (data size) is written on their packages (outer casing). However, depending on the user, data may be recorded at a picture size (data size) that is completely different from this reference picture size. In this case, there is not much point in providing the above-mentioned written indication of the number of pictures that can be captured and recorded.

Further, at the present time, there are still quite a few users who are not familiar with digital equipment, for example. It is difficult for such users to perceptually associate the concept of data size units such as MB (megabyte) or GB (gigabyte) with the number of pictures that can be captured. It would be too much to expect such users to choose a memory card with an appropriate capacity by relying solely on an indication of memory card capacity, and also the users will always feel uneasy when purchasing a memory card. It should be noted that a digital still camera with a variable picture size is disclosed in, for example, Japanese Unexamined Patent Application Publication No. 2001-8088.

According to an embodiment of the present invention, there is provided an image capturing apparatus including: captured still image data generating means for converting captured light into an electrical signal and generating captured still image data representing a still image from the electrical signal; recording means for recording the captured still image data onto a recording medium; free-capacity recognizing means for recognizing a free capacity on the recording medium; prescribed-maximum-possible-record-count calculating means for calculating a prescribed maximum possible record count indicating the maximum number of pieces of captured still image data that are allowed to be recorded, in accordance with the free capacity; and parameter determining means for determining a parameter to be set on the captured still image data generating means and used for adjusting a data size of the captured still image data, in which the parameter determining means determines the parameter such that a data size of the captured still image data is adjusted to a data size that allows captured still image data equal to the prescribed maximum possible record count to be recorded onto the recording medium while making maximum use of the free capacity.

In the image capturing apparatus mentioned above, the prescribed-maximum-possible-record-count calculating means may further include prescribed-maximum-allowed-record-count recognizing means for recognizing a prescribed maximum allowed record count with respect to the recording medium on the basis of prescribed maximum allowed record count information, which is recorded on the recording medium in advance and indicates the prescribed maximum allowed record count representing the maximum number of pieces of captured still image data that are allowed to be recorded onto the recording medium, and recorded count information recognizing means for recognizing a recorded count indicating the number of pieces of captured image data that have already been recorded on the recording medium, and the prescribed maximum possible record count may be calculated using the prescribed maximum allowed record count and the recorded count.

In the image capturing apparatus mentioned above, the parameter determining means may execute a data-size sequentially changing control of changing a data size of the captured still image data so as to become sequentially smaller within a range from maximum to minimum, and the parameter determining means may determine the parameter by changing a data size of the captured still image data so as to become sequentially smaller by the data-size sequentially changing control, and terminating the data-size sequentially changing control upon obtaining a data size of the captured still image data that allows the captured still image data equal to the prescribed maximum possible record count to be recorded onto the recording medium so as to make maximum use of the free capacity.

In the image capturing apparatus mentioned above, the parameter determining means may change a compression ratio for the captured still image data as the parameter in executing the data-size sequentially changing control.

In the image capturing apparatus mentioned above, the parameter determining means may change a picture size of the captured still image data as the parameter in executing the data-size sequentially changing control.

In the image capturing apparatus mentioned above, the parameter to be changed for the data-size sequentially changing control may include a compression ratio for the captured still image data and a picture size of the captured still image data, and as the data-size sequentially changing control, under a condition in which one picture size is being set, the parameter determining means may sequentially change a compression ratio at the set picture size to become higher by one level at a time, and at the next level after the highest compression ratio is set, the parameter determining means may execute changing to a one-level smaller picture size.

In the image capturing apparatus mentioned above, when the parameter determining means executes changing to a one-level smaller picture size as the data-size sequentially changing control, the parameter determining means may execute changing to the lowest compression ratio among compression ratios at the changed picture size.

In the image capturing apparatus mentioned above, the prescribed-maximum-possible-record-count calculating means may calculate the prescribed maximum possible record count on the basis of the prescribed maximum allowed record count, only when the prescribed maximum record count is recorded on the recording medium.

According to an embodiment of the present invention, there is provided an image capturing method including the steps of: converting captured light into an electrical signal, and generating captured still image data representing a still image from the electrical signal; recording the captured still image data onto a recording medium; recognizing a free capacity on the recording medium; calculating a prescribed maximum possible record count indicating the maximum number of pieces of captured still image data that are allowed to be recorded, in accordance with the free capacity; and determining a parameter used for adjusting a data size of the captured still image data, in which in the determining step, the parameter is determined such that a data size of the captured still image data is adjusted to a data size that allows captured still image data equal to the prescribed maximum possible record count to be recorded onto the recording medium while making maximum use of the free capacity.

### BRIEF DESCRIPTION OF THE DRAWINGS

FIGS. 1A to 1D are views showing the outward appearance of a digital still camera according to an embodiment of the present invention;

FIG. 2 is a block diagram of a digital still camera according to an embodiment of the present invention;

FIG. 3 is a configuration diagram of a memory card as a recording medium (recording medium apparatus) supported by a digital still camera according to an embodiment of the present invention;

FIG. 4 is a diagram showing an example of the directory structure applied to a memory card according to an embodiment of the present invention;

FIG. 5 is a flowchart showing an example of processing procedure for setting data-size-related parameters;

FIG. 6 is a flowchart showing an example of procedure as step S108 in FIG. 5;

FIG. 7 is a diagram showing an example of data-size-related parameters (picture size and compression ratio) that can be set for a digital still camera according to an embodiment of the present invention; and

FIG. 8 is a diagram schematically showing an example of partition splitting with respect to the recording area of a maximum-record-count-specified memory card.

### DESCRIPTION OF THE PREFERRED EMBODIMENTS

Hereinbelow, the best mode for carrying out the present invention (hereinafter, referred to as embodiment) will be described. This embodiment is directed to a case where the configuration based on the present invention is applied to an image capturing apparatus as a digital still camera.

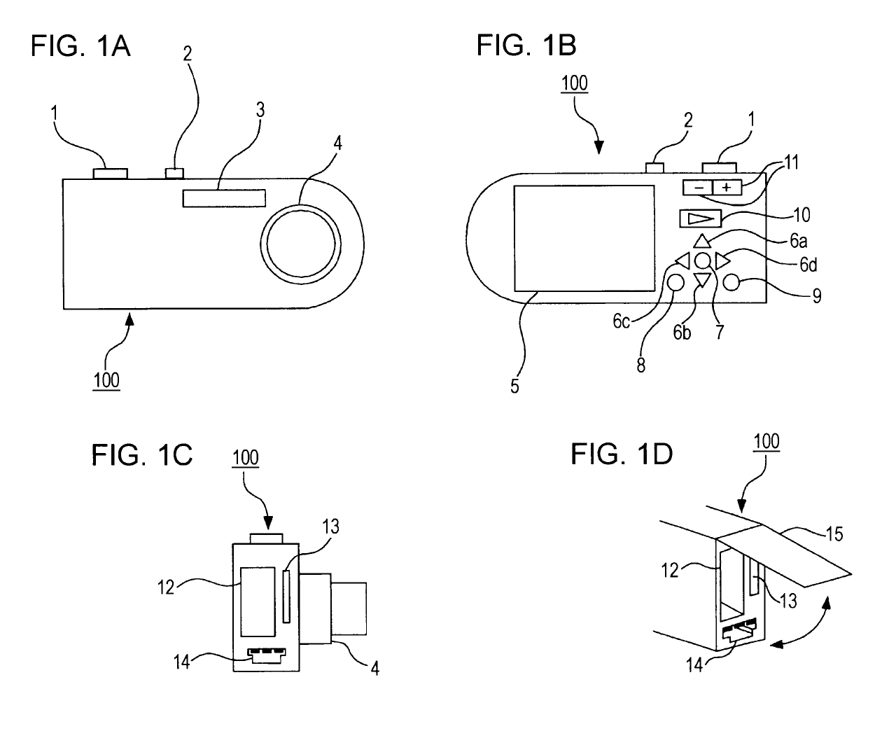

First, an example of the outward appearance of a digital still camera 100 according to this embodiment will be described with reference to FIGS. 1A to 1D. FIGS. 1A, 1B, 1C, and 1D are a front view, rear view, side view, and perspective view of the digital still camera 100, respectively. The perspective view of FIG. 1D shows the side portion shown in FIG. 1C as viewed slightly from the rear.

As shown in, for example, FIGS. 1A and 1B, a shutter key 1 and an on/off key 2 are arranged on the top portion of the main body of the digital still camera 100 according to this embodiment. When the shutter key 1 is operated, an image captured at that operation timing is recorded onto a recording medium (memory card 40) as captured image data corresponding to one still image picture (captured still image data). The on/off key 2 is used to control on/off of the power of the digital still camera 100, and on/off of the image capture mode.

Further, as shown in FIG. 1A, a flash section 3, and an image-capturing lens section 4 are provided on the front portion of the digital still camera 100. The flash section 3 fires a so-called strobe light in accordance with the timing of image capture and recording (exposure). Further, a captured image is taken in by the image-capturing lens section 4 as captured light.

As shown in FIG. 1B, on the rear portion of the main body of the digital still camera 100, there are provided a display screen section 5, cursor move keys 6a, 6b, 6c, and 6d, an enter key 7, a menu key 8, a display switching key 9, a captured image playback key 10, and a zoom key 11.

The display screen section 5 serves as the display screen of a display device such as an LCD (Liquid Crystal Display), for example. Although also depending on the actual size of the digital still camera 100, the common size of the display screen section 5 is about two to three inches, for example. When in the image capture mode, a live view is displayed on the display screen section 5. The user as an image capturer can perform still image capture while looking at an image displayed on the display screen section 5 instead of a viewfinder.

The cursor move keys 6a, 6b, 6c, and 6d are keys corresponding to directions of up, down, left, and right, respectively. For example, when a cursor is displayed on the display screen section 5, the cursor can be moved up, down, to the left, and to the right by operating the cursor move keys 6a, 6b, 6c, and 6d. It should be noted that the cursor move keys 6a, 6b, 6c, and 6d allow not only cursor movements but also other operations depending on the operating state of the digital still camera 100 at that time, such as an operation with respect to a playback image displayed on the display screen section 5.

The enter key 7 arranged at the center portion among the cursor move keys 6a, 6b, 6c, and 6d can be depressed, and is used for various operations including an operation for selecting and entering an item to which the cursor is positioned.

The menu key 8 is a key that is operated to display a screen serving as a main menu, for example, as a menu screen for allowing the user to make various settings on the digital still camera 100.

The display switching key 9 is a key for switching an image displayed on the display screen section 5.

The captured image playback key 10 is operated to start an operation of displaying on the display screen section 5 a still image obtained by playing back captured image data recorded on a recording medium (memory card 40).

The zoom key 11 is an operating member used to change the angle of view of an image captured by the image-capturing lens section 4. Operating the zoom key 11 to the “+” (wide) side allows capture of an image with a wider angle of view, and operating the zoom key 11 to the “−” (telephoto) side allows capture of a telephoto image with a narrower angle of view.

As shown in FIGS. 1C and 1D, on a side portion of the main body of the digital still camera 100, there are provided a battery insertion opening 12, a memory card insertion opening 13, and a USB (Universal Serial Bus) terminal 14, which are protected by a protective cover 15 that can be opened.

The battery insertion opening 12 is a portion into which the battery for supplying power to the digital still camera 100 is inserted.

The memory card insertion opening 13 is a portion into which the memory card 40, which is a removable recording medium whose outer shape conforms to predetermined standards, is loaded. The digital still camera 100 according to this embodiment records captured image data onto the memory card loaded in the memory card insertion opening 13.

The digital still camera 100 according to this embodiment supports USB mass storage class, and thus allows a host such as a personal computer to access the memory card 40 loaded in the digital still camera 100 via a USB interface. This makes it possible for, for example, an image management application or the like on the personal computer side to read captured image data recorded on the memory card loaded on the digital still camera 100 side for saving the captured image data or the like. The USB terminal 14 is a portion into which the plug portion of a USB cable is inserted when connecting host equipment and the digital still camera 100 with each other by the USB interface in this way.

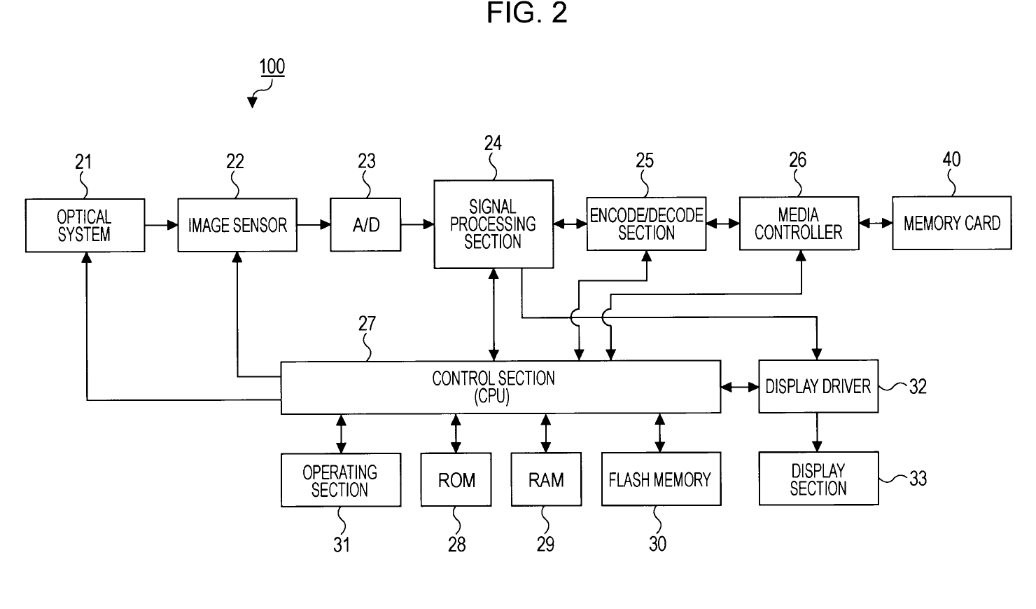

The block diagram of FIG. 2 shows an example of the internal configuration of the digital still camera 100 according to this embodiment.

In FIG. 2, first, an optical system section 21 includes, for example, a group of lens used for image capture, including a zoom lens, a focus lens, and the like, an iris, and the like. The optical system section 21 causes incident light as captured light to be imaged on the light-receiving surface of the image sensor 22. It should be noted that the image-capturing lens section 4 described above with reference to FIGS. 1A to 1D is included in the optical system section 21 as referred to herein.

Further, the optical system section 21 also includes driving mechanism sections for driving the zoom lens, focus lens, the iris, and the like mentioned above. The operations of these driving mechanism sections are controlled by so-called camera controls executed by a control section 27 such as zoom control, automatic focus control, and automatic exposure control, for example.

An image sensor 22 carries out so-called photoelectric conversion by which captured light obtained at the optical system section 21 is converted into an electrical signal. To this end, the image sensor 22 receives captured light from the optical system section 21 on the light-receiving surface of a photoelectric conversion element, and sequentially outputs signal charges accumulated in accordance with the intensity of received light. An electrical signal (image-capturing signal) corresponding to captured light is outputted. While the photoelectric conversion element (image-capturing element) adopted as the image sensor 22 is not particularly limited, examples of such a photoelectric conversion element available at present include a CMOS sensor and a CCD (Charge Coupled Device). In a case where a CMOS sensor is adopted, a device (part) corresponding to the image sensor 22 can be implemented as a structure also including an analog-digital converter corresponding to an A/D converter 23 that will be described next.

An image-capturing signal outputted from the image sensor 22 is inputted to the A/D converter 23 to be converted into a digital signal before being inputted to a signal processing section 24.

The signal processing section 24 takes in a digital image-capturing signal outputted from the A/D converter 23 in units equivalent to one still image (frame image), for example, and applies signal processing to the image-capturing signal in units of still image thus taken in, thereby generating captured image data (captured still image data) as image signal data equivalent to one still image picture.

To record the captured image data generated by the signal processing section 24 in the above-mentioned manner as captured image information corresponding to a still image onto the memory card 40 as a recording medium (recording medium apparatus), for example, captured image data corresponding to one still image is outputted from the signal processing section 24 to an encode/decode section 25.

The encode/decode section 25 executes compression encoding by a still image compression encoding scheme with respect to the captured image data in units of still image outputted from the signal processing section 24, and adds a header or the like in accordance with control of the control section 27, for example, thus effecting conversion into a compressed captured image data format. Then, the captured image data thus generated is transferred to a media controller 26. In accordance with control of the control section 27, the media controller 26 writes the transferred captured image data into the memory card 40 for recording. It is stated here for confirmation that the memory card 40 is inserted in the memory card insertion opening shown in FIGS. 1C and 1D.

Further, the digital still camera 100 causes the display section 33 to execute image display by using captured image data obtained at the signal processing section 24, thereby making it possible to display a so-called live view that is an image being currently captured. For example, in the signal processing section 24, an image-capturing signal outputted from the A/D converter 23 is taken in to generate captured image data equivalent to one still image as described above. By continuing this operation, captured image data equivalent to a frame image in a moving picture is sequentially generated. Then, the captured image data sequentially generated in this way is transferred to a display driver 32 in accordance with control of the control section 27. In this way, a live view is displayed.

The display driver 32 generates a drive signal for driving the display section 33 on the basis of the captured image data inputted from the signal processing section 24 as mentioned above, and outputs the drive signal to the display section 33. Images based on captured image data in units of still image are thus sequentially displayed on the display section 33. When this operation is viewed from the user, an image being captured at that time is displayed on the display section 33 in the manner of a moving picture. That is, a monitor image is displayed. It should be noted that the display screen section 5 described above with reference to FIGS. 1A to 1D corresponds to the screen portion of the display section 33 in this case.

Further, the digital still camera 100 is also capable of playing back captured image data recorded on the memory card 40 and displaying the resulting image on the display section 33.

To this end, the control section 27 specifies captured image data, and commands the media controller 26 to read data from the memory card 40. In response to this command, the media controller 26 executes reading of data by accessing an address on the memory card 40 where the specified captured image data is recorded, and transfers the read data to the encode/decode section 25.

In accordance with control of the control section 27, for example, the encode/decode section 25 extracts real data as compressed still image data from the captured image data transferred from the media controller 26, and executes a decoding process with respect to compression encoding applied to this compressed still image data, thereby obtaining captured image data corresponding to one still image. Then, the encode/decode section 25 transfers this captured image data to the display driver 32. An image of captured image data recorded on the memory card 40 is thus played back for display on the display section 33.

In addition to the monitor image or playback image of captured image data mentioned above, a user interface image can be also displayed on the display section 33. In this case, for example, the control section 27 generates display image data as a required user interface image in accordance with the operating state or the like at that time, and outputs this display image data to the display driver 32. A user interface image is thus displayed on the display section 33. It should be noted that this user interface image can be displayed on the display screen of the display section 33 separately from the monitor image or playback image of captured image data, such as in the form of a specific menu screen, for example, or can be displayed so as to be superimposed/synthesized on a part of the monitor image or playback image of captured image data.

In actuality, the control section 27 includes a CPU (Central Processing Unit), for example, and constitutes a microcomputer together with a ROM 28, a RAM 29, and the like. In addition to programs to be executed by the CPU as the control section 27, for example, various kinds of setting information related to the operation of the digital still camera 100 are recorded in the ROM 28. The RAM 29 serves as the main recording device for the CPU.

Further, a flash memory 30 in this case is provided as, for example, a non-volatile recording area used for recording various kinds of setting information that needs to be changed (rewritten) in accordance with a user's operation, activity log, or the like. It should be noted that, for example, in a case where a non-volatile memory such as a flash memory is adopted as the ROM 28, a part of the recording area in the ROM 28 may be used instead of the flash memory 30.

An operating section 31 collectively represents various operating members included in the digital still camera 100, and an operating information signal outputting part that generates operating information signals according to operations made on these operating members and outputs the operating information signals to the CPU. The control section 27 executes a predetermined process in accordance with an operating information signal inputted from the operating section 31. An action of the digital still camera 100 according to a user's operation is thus executed. It is stated here for confirmation that the shutter key 1, the on/off key 2, the cursor move keys 6a, 6b, 6c, and 6d, the menu key 8, the display switching key 9, the captured image playback key 10, and the zoom key 11 each serve as an operating member included in the operating section 31.

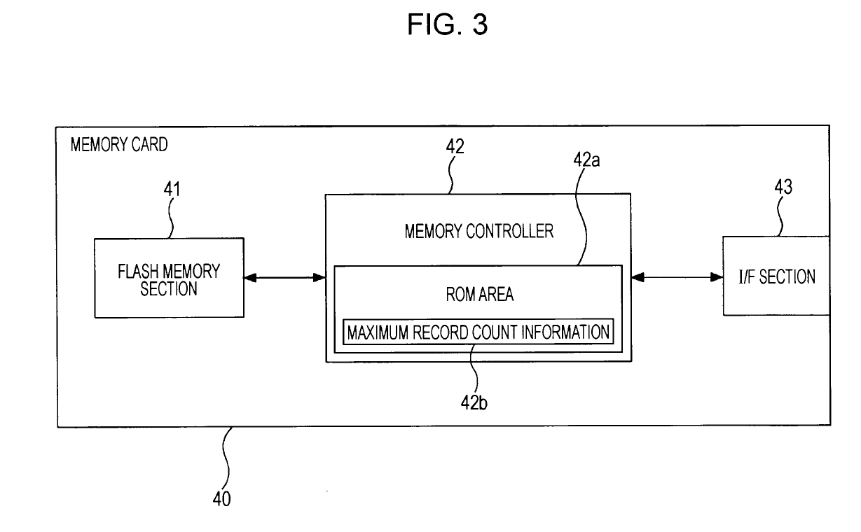

FIG. 3 shows an example of the internal configuration of the memory card 40, which is a type of recording medium (recording medium apparatus) supported by the digital still camera 100 according to this embodiment.

As shown in FIG. 3, the memory card 40 includes a flash memory section 41, a memory controller 42, and an interface section 43.

The flash memory section 41 is a data recording area including a rewritable non-volatile semiconductor recording element called a flash memory. In actuality, captured image data to be recorded by the digital still camera 100 according to this embodiment is written into the flash memory section 41 for recording. It should be noted that as for the capacity of the flash memory section 41, at present, it is common to mount one with a capacity on the order of several hundred MBs (megabytes) to several hundred GBs (gigabytes).

The memory controller 42 executes memory control such as reading and writing of data to and from the flash memory section 41. To elaborate on the above explanation, processes such as error correction corresponding to a flash memory, and physical address-logical address conversion are performed by the memory controller 42.

Further, the memory controller 42 contains a ROM area 42a, which is a non-rewritable low-capacity recording area. The ROM area 42a generally stores information such as various characteristics of a flash memory, or parameters required for an error correction process or the like. In this connection, in accordance with this embodiment, maximum record count information 42b is recorded in the ROM area 42a. A description of the maximum record count information 42b will be given later.

The interface (I/F) section 43 is a part allowing communication between a drive (in this embodiment, the media controller 26 on the digital still camera 100 side) that drives the memory card 40, and the memory controller 42 within the memory card 40. Although not shown, the memory card 40 has the number of terminals that conform to a standard. To establish communication with the drive side, the memory card 40 is inserted into a slot (memory card insertion opening), and the above-mentioned terminals are electrically connected with the drive side, thus enabling communication via the interface 43.

The digital still camera 100 according to this embodiment records captured image data (captured still image data) onto the memory card 40, in compliance with the DCF (Design rule for Camera File system) standard, which is a camera file system standard developed under the JEIDA (Japanese Electronic Industry Development Association).

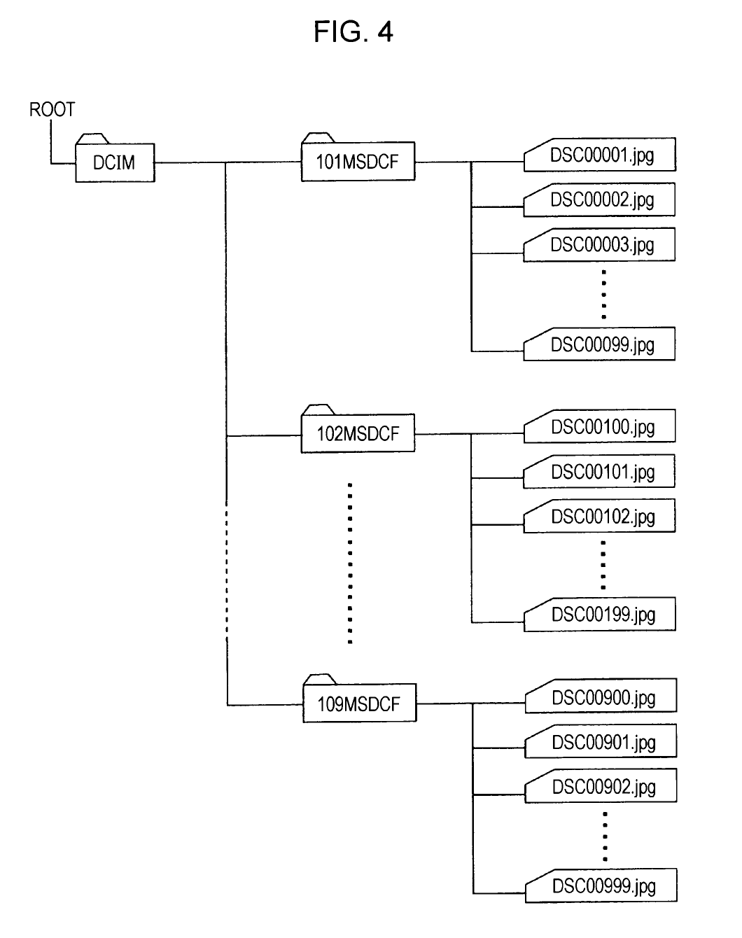

Now, by way of reference, FIG. 4 provides a brief description of the directory structure of a recording medium in a case where captured image data is recorded in compliance with the DCF standard.

First, “DCF image root directory”, which is a directly with the came DCIM (Digital Camera IMages), is arranged directly below the ROOT directory.

Next, directly under the above-mentioned DCF image root directory, a maximum of 900 “DCF directories”, which are directories that store DCF files (DCF objects), can be arranged. The directory name of such a DCF directory is defined as follows:
The directory name is 8 characters in length.
The first to third characters shall use a directory number between “100” and “999”.
The rest of the name from the fourth character shall be five characters (i.e., a total of 8 characters), for which half-size upper-case alphanumeric characters defined as usable shall be used.

FIG. 4 shows a case in which 9 DCF directories with the names “101MSDCF”, “102MSDCF”, . . . “109 MSDCF” are arranged.

As for DCF files stored in DCF directories, the file mane of a DCF file is defined as follows.
The directory name is 8 characters in length.
The first to fourth characters shall use free characters (half-size upper-case alphanumeric characters) defined as usable.
The fifth to eighth characters shall use a file number between “0001” and “9999”.

In FIG. 4, each DCF directory stores DCF files having the free characters DSC0, with a number between 0001 to 9999 being used as the file number that follows.

Specifically, the DCF directory 101MSDCF stores files DSC0001.jpg to DSC0099.jpg (.jpg is an extension for identifying a file type). As can be understood from the addition of the extension .jpg, these files are still image files in the JPEG (Joint Photographic Expert Group) format. For example, the captured image data to be recorded onto the memory card 40 by the digital still camera 100 according to this embodiment is actually in the form of such a JPEG file.

As for such a memory card mentioned above, as previously described, it is common to produce several variations of the same memory card with different recording capacities under a single memory card standard. Such memory cards are usually differentiated by capacity for sale/offer to the general users, such as by writing an indication of numerical values representing such recording capacities (i.e., 512 B or 1 GB) on their packages.

Other than being used as the recording media for digital still cameras, memory cards are also used as the recording media for various kinds of digital equipment such as a mobile telephone or a mobile content player, for example. Further, depending on the usage or the like of the digital equipment used, there are diverse types of information recorded on a memory card other than still images, such as moving pictures and sound, for example. In this respect, memory cards are inherently general purpose.

With the above-mentioned circumstances in mind, it would be appropriate to clearly indicate a recording capacity value, which is a numerical value representing the recording capacity of a memory card, on the package or the like at the time of sale or offer, so that the user can choose a memory card that is suitable for his/her own intended use by looking at the indicated recording capacity value.

However, assuming that the use of a memory card is limited to a digital still camera, as previously described, an indication based on the recording capacity value makes it difficult for many users to accurately grasp the number of pieces of captured image data that can be recorded.

In the case of digital still cameras, in particular, the current widespread use of digital still cameras is a result of a gradual shift from silver-halide film cameras (film cameras). With this situation as a backdrop, it is even more difficult for users who are not familiar with digital equipment and are still more used to film cameras to associate the indication based on the recording capacity value mentioned above with the number of pieces of captured image data that can be recorded (i.e., the number of still image pictures that can be captured). Even when such a user wants to buy a memory card, for example, he/she does not know which memory card is the right memory card to buy, so the user may find some inconvenience regarding the use of memory cards.

In view of this, in accordance with this embodiment, the following arrangement is adopted to eliminate such inconvenience. That is, first, the concept of recording capacity which the users need to be aware of is basically done away with. Instead, the maximum value of the number of still image pictures (the number of pieces of captured image data) that can be captured and recorded on a memory card is determined, and such a memory card is offered to the general users.

Specifically, for each memory card conforming to a standard that is supported by the digital still camera 100 according to this embodiment, for example, the maximum number of pieces of captured image data that can be captured and recorded on the memory card is determined as, for example, 30, 50, or 100. It should be noted that the above-mentioned maximum number of pieces of captured image data that can be captured and recorded is herein referred to as the “maximum record count (prescribed maximum allowed record count)”. Further, at the present time, the number of pieces of captured image data captured and recorded on a digital still camera is commonly counted by the number of pictures, similar to the actual photographs. Thus, in the following description, the number of pieces of captured image data will be often indicated by the number of pictures where appropriate.

For the sale or offering of such a memory card, for example, first, the above-mentioned maximum record count is clearly written on its package, a memory card label, or the like. That is, when selling or offering a film used in a film camera, the maximum number of still image pictures that can be captured with the film, typically expressed as “ . . . shots” or the like, is written on the package, the roll cover of the film, or the like. The idea here is to provide the same indication with respect to a memory card.

It should be noted that a memory card with a specified maximum record count which is offered in this way is hereinafter also referred to as the maximum-record-count-specified memory card.

As a matter of course, being a memory card, this maximum-record-count-specified memory card has also a given recording capacity. Whether or not to write this recording capacity value along with the maximum record count may be determined in accordance with the manner in which the memory card is sold and offered. It should be noted, however, that as will be appreciated from a description given later, when used for digital equipment other than the digital still camera 100 according to this embodiment, such a memory card with a specified maximum record count can be used as an normal memory card. With this in mind, normally, it would be appropriate to also provide a written indication of the recording capacity value when selling/offering such a memory card.

One way to set the relationship between the maximum record count on the maximum-record-count-specified memory card and the recording capacity thereof is as follows. That is, on the basis of the picture size or the like which is generally considered to be used frequently, the data size of a single standard picture of captured image data is found. Then, in correspondence to each of the actual recording capacities of memory cards that are available at present, the number of pieces of captured image data with the above-mentioned standard data is determined as the maximum record count.

When loaded with the maximum-record-count-specified memory card as the memory card 40, the digital still camera 100 according to this embodiment performs a control such that captured image data is recorded onto this memory card only up to the maximum record count indicated by the maximum record count information 42b.

This means that the combination of the maximum-record-count-specified memory card and the digital still camera 100 according to this embodiment can be used in much the same way film cameras were used in the past. That is, when acquiring a memory card equivalent to a film by, for example, purchase, the user first looks at the indicated maximum count (written indication of the number of shots that can be taken) and chooses an appropriate memory card. When the acquired maximum-record-count-specified memory card is loaded into the digital still camera 100 according to this embodiment for use, once image capture and recording have been done up to the indicated maximum record count, no more data can be recorded onto this maximum-record-count-specified memory card, just like when a film is used up.

As mentioned above, when used in combination in this way, the memory card and the digital still camera according to this embodiment can be used by the user in much the same way as a film camera. Therefore, the use of a digital still camera, including such phases as the acquisition and management of a memory card, can be made simpler and easier to understand than in the past. This makes the transition to digital still cameras extremely easy particularly for users who are not familiar with digital equipment and have previously used only film cameras.

Next, a description will be given of an example of the technical configuration that makes it possible for the digital still camera 100 according to this embodiment to record captured image data onto the maximum-record-count-specified memory card as mentioned above.

First, in a case where the memory card 40 conforming to a standard that is supported by the digital still camera 100 according to this embodiment is offered as the maximum-record-count-specified memory card, as shown in FIG. 4, the maximum record count information 42b, which is information indicating the maximum record count set with respect to this memory card, is recorded to a suitable address on the ROM area 42a of the memory controller 42 again.

While it may be possible to record the maximum record count information 42b to a predetermined area in the flash memory section 41, for example, the recording area as the flash memory section 41 is essentially provided as an area for recording user data such as captured image data in accordance with a predetermined format, and data recorded in this recording area is completely erased upon initialization. For example, even if a configuration is employed in which the maximum record count information 42b is recorded onto the flash memory section 41, and initialization is executed with respect to equipment such as the digital still camera 100 supporting the maximum-record-count-specified memory card in such a way as not to erase or rewrite the maximum record count information 42b, in actual use, there is no denying the possibility that formatting is done by equipment that does not support the maximum-record-count-specified memory card. In this case, the maximum record count information 42b recorded on the flash memory section 41 is almost certainly erased. On the other hand, as previously described, the ROM area 42a within the memory controller 42 is a non-rewritable area, and thus not affected by the initialization of the flash memory section 41. For this reason, in this embodiment, recording is performed with respect to the ROM area 42b.

When the maximum-record-count-specified memory card is loaded, the digital still camera 100 according to this embodiment is operated to recognize the maximum record count indicated by the maximum record count information 42b stored in the memory card, and prohibit recording of captured image data beyond the recognized maximum record count so that captured image data is recorded onto this maximum-record-count-specified memory card only up to the maximum record count. Thus, at least, the number of captured image data recorded onto the maximum-record-count-specified memory card is limited to up to the specified maximum record count, so the intended usage and purpose of the maximum-record-count-specified memory card are accomplished.

However, in the case of a digital still camera, it is usually possible to change the data size of captured image data when in a format in which the captured image data is actually recorded onto a memory card. For this reason, when recording captured image data onto the maximum-record-count-specified memory card, it would be necessary to consider how the data size of captured image data should be set.

That is, if the data size of captured image data to be recorded onto the memory card is too large, the recording capacity of the memory card becomes full before captured image data is recorded up to the specified maximum record count, so the intended usage of the maximum-record-count-specified memory card cannot be accomplished. On the other hand, if the data size of captured image data to be recorded onto the memory card is small, captured image data can be recorded up to the specified maximum record count. However, a considerable free capacity remains even after captured image data is recorded up to the maximum record count, making it difficult to effectively use the recording capacity of the memory card.

In view of this, it can be said that the data size of captured image data to be recorded onto a memory card should be set so as to make the maximum use of the recording capacity of the memory card, while bearing in mind that the data size should allow the number of pieces of captured image data indicated by the maximum record count to be recorded on the memory card. That is, it would be ideal if the remaining capacity on a memory card is substantially zero in a state where an amount of captured image data matching the maximum record count is already recorded on the memory card. Setting the data size of captured image data so as to make the actual state as close as possible to this state is preferred for making effective use of the recording capacity.

Further, the data size of captured image data generally depends on the so-called picture size, which is a pixel count expressed by the horizontal pixel count x the vertical pixel count set at the time of image capture. Further, in the case of captured image data to which still image compression encoding based on the JPEG scheme, for example, is applied as in the case of the captured image data generated by the digital still camera 100 according to this embodiment, the data size of captured image data also depends on the compression ratio that is set at the time of encoding the captured image data. The above picture size and compression ratio as parameters also serve as parameters for determining whether the image quality of a played back and outputted still image is good or not in the manner as known in the art. This means that to determine the data size of captured image data that can make the maximum use of the recording capacity of a memory card is to determine the data size that can provide the best image quality in accordance with the recording capacity of the memory card or the remaining capacity on the memory card at that time.

Accordingly, the digital still camera 100 according to this embodiment is configured so that when recording captured image data onto the maximum-record-count-specified memory card as mentioned above, eventually, the data size of captured image data that can make the maximum use of the recording capacity of the memory card is automatically set.

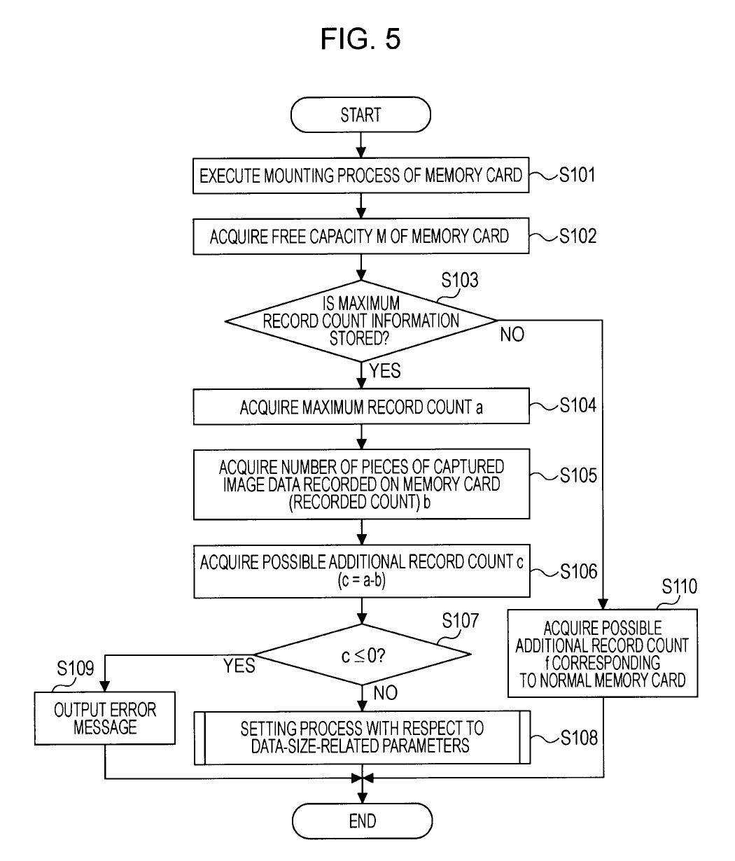

The flowchart of FIG. 5 shows an example of the processing procedure executed by the digital still camera 100 to automatically set the data size of captured image data in the above-mentioned manner. It should be noted that the processes shown in this drawing can be regarded as operations that can be attained by the control section (CPU) 27 executing a program recorded on the ROM 28 or the flash memory 30. Further, other than being written and recorded onto the ROM 28 or the flash memory 30 at the time of manufacture or the like, this program may be first recorded on a memory card, and then installed (including updating) from this recording medium to be recorded onto the flash memory 30. Further, the program may be installed by control from another equipment serving as a host via USB connection. Further, it may be also possible to adopt a configuration in which the program is recorded onto a recording device in a server or the like on the network in advance, and the digital still camera 100 is endowed with a network capability so that the program can be acquired by downloading from the server and installed onto the flash memory 30.

For example, if the power of the digital still camera 100 is turned ON in a state with the memory card 40 loaded, or if the memory card 40 is loaded into the memory card insertion opening 13 anew in a state with the power of the digital still camera 100 turned ON, in step S101, the digital still camera 100 (control section 27) first executes a mounting process with respect to the loaded memory card. When this mounting process is completed, subsequently, so-called file operations, including writing, reading, deletion, and the like of data or files with respect to the memory card 40, can be performed by a host application that is realized by the control section 27 (CPU) executing a program.

When the mounting process is completed in step S101, the procedure from step S102 onwards is executed. If the memory card being mounted (i.e., being loaded at this time) is a maximum-record-count-specified memory card, through the process from step S102 onwards, settings on the data size of captured image data are eventually performed. That is, in this case, a setting process on the data size of captured image data is executed every time a mounting process is performed.

In step S102, the free capacity (remaining capacity) M on the mounted memory card 40 is recognized. This can be recognized through processing on the file system hierarchy, for example.

In step S103 that follows, the ROM area 42a of the mounted memory card 40 is accessed to determine whether or not the maximum record count information 42b is stored in the ROM area 42a. First, if a negative determination result is obtained in step S103, this means that the mounted memory card 40 is not a maximum-record-count-specified memory card but is an ordinary memory card.

In a case where an ordinary memory card is loaded, when in the image capture and recording mode, the digital still camera 100 executes recording of normal captured image data as in the related art. That is, simply, image capture and generation of captured image data are performed in accordance with the picture size and compression ratio set by the user at that time, and the captured image data is recorded onto the memory card 40. Further, when performing normal image capture and recording as described above, the number of pieces of captured image data that can be recorded with the current free capacity on the current memory card (possible additional record count) on the basis of the current data size of captured image data is often indicated on the display screen section displaying a live view, for example. The digital still camera 100 according to this embodiment can also display this possible additional record count at the time of normal image capture and recording. Accordingly, if a negative determination result is obtained in step S103, in step S110, the above-mentioned possible additional record count “f” is found and acquired.

To find the possible additional record count “f” corresponding to the ordinary memory card mentioned above, for example, assuming that the data size of captured image data when in a format in which the captured image data is actually recorded onto the memory card (for example, in the form of one JPEG-format file) is p, by using the free capacity M acquired in step S102 above, an integer quotient found by the calculation of M/p may be set as the possible additional record count “f”.

On the other hand, if a positive determination result is obtained in step S103, the process proceeds to step S104.

In step S104, a maximum record count “a” indicated by the maximum record count information 42b is acquired. It should be noted that in accordance with the flow of process from step S103 to step S104 mentioned above, for example, an operation of outputting the maximum record count indicated by the maximum record count information 42b in the ROM area 42a from the memory card 40 as the maximum-record-count-specified memory card being loaded, to the control section (CPU) of the digital still camera 100 can be regarded as being performed within that flow.

In step S105 that follows, the number of pieces of captured image data (number of still image files (JPEG format)) recorded on the mounted maximum-record-count-specified memory card is recognized from the processing layer where file operations are performed at a level higher than the file system layer, for example, and this is acquired as a recorded count “b”.

In step S106 that follows, a possible additional record count (prescribed maximum possible record count) “c” on the mounted maximum-record-count-specified memory card is found and acquired.

The possible additional record count “c” refers to the number of pieces of captured image data that can be recorded in addition to already recorded captured image data before reaching the maximum record count. This possible additional record count “c” can be found as follows using the maximum record count “a” acquired in step S104, and the recorded count “b” acquired in step S105.

c=a−b (Equation 1)

In step S107, it is determined with respect to the possible additional record count “c” found by “Equation 1” mentioned above whether or not c≦0. c≦0 corresponds to a case where captured image data equal to the maximum record count has already been recorded (c=0), or a case when captured image data exceeding the maximum record count is recorded, on the mounted maximum-record-count-specified memory card. The latter can occur in cases such as when, for example, captured image data exceeding the maximum record count is recorded as a result of previous film operations performed with another digital equipment that does not support a maximum-record-count-specified memory card.

The digital still camera 100 according to this embodiment supports a maximum-record-count-specified memory card. Accordingly, in a case where captured image data exceeding the maximum record count has been recorded on the maximum-record-count-specified memory card, the digital still camera 100 is operated so as not to execute any further recording of captured image data.

If a positive determination result is obtained in step S107, the process proceeds to step S109, and a process for outputting an error message is executed. For example, an indication stating that “captured image data exceeding the maximum record count has already been recorded on the memory card 40 being currently loaded, and thus no more recording of captured image data is possible”, and prompting “replacement with a maximum-record-count-specified memory card for which the number of shots has not reached the maximum record count (which has a remaining free capacity)”, is displayed on the display screen section 5.

In contrast, if a negative determination result is obtained in step S107, that is, if an integer value of 1 or larger is obtained as the possible additional record count “c”, the process proceeds to step S108.

In step S108, a determination process with respect to data-size-related parameters is executed. Thus, the data size of captured image data to be recorded onto the maximum-record-count-specified memory card being currently mounted is determined.

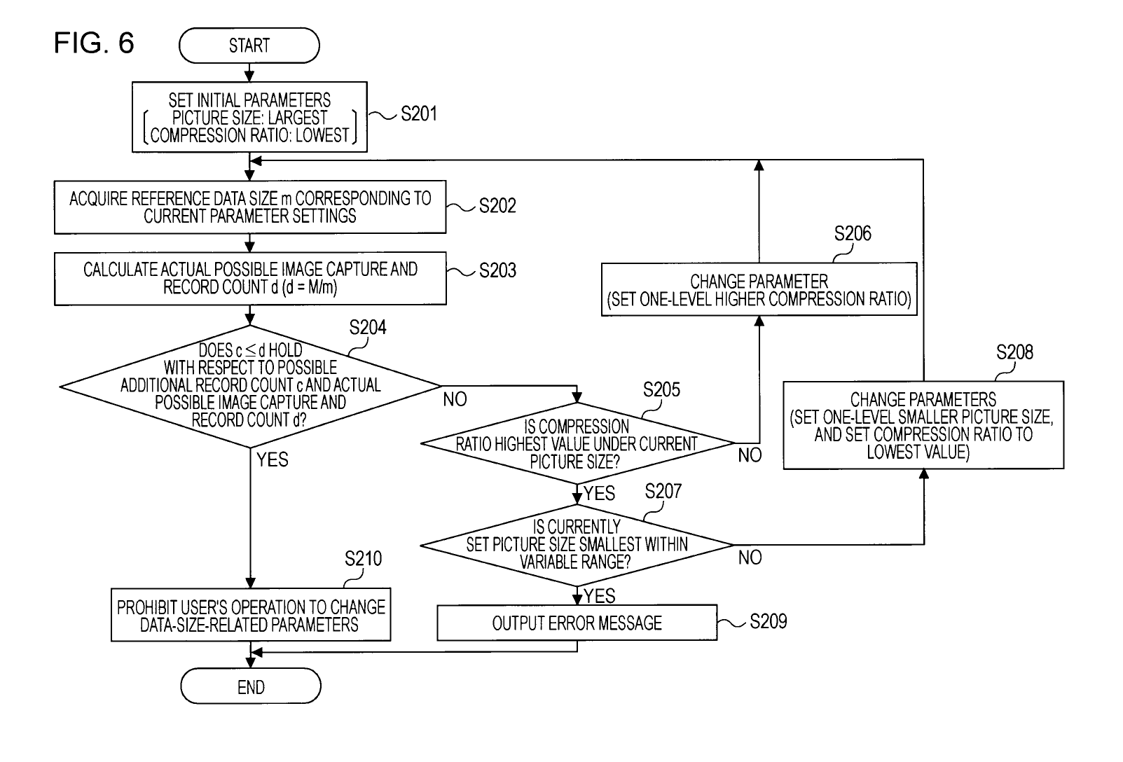

The flowchart of FIG. 6 shows an example of the processing procedure in the determination process of data-size-related parameters as step S108 mentioned above.

It should be noted that data-size-related parameters refer to those parameters which determine the data size of captured image data when in a still image file format (e.g. JPEG format) in which the captured image data is written and recorded onto the memory card, from among parameters (set values) to be set during the process after image capture is performed by the optical system section 21 until captured image data in a file format is recorded onto the memory card 40. As previously described, one of these data-size-related parameters is the so-called picture size corresponding to the pixel count representing the horizontal/vertical pixel counts of a captured image, and the other is the compression ratio applied in the still image compression encoding process. In correspondence to FIG. 2, the picture size is set with respect to the image sensor 22. The image sensor 22 is configured to output captured light received on its light-receiving surface as an image-capturing signal based on the horizontal/vertical pixel counts corresponding to the picture size being set. The picture size of a captured image when generated as a still image file is thus determined. Further, the compression ratio parameter is set with respect to the encode/decode section 25. The encode/decode section 25 is configured to execute a still image compression process at the compression ratio thus set. Then, when the picture size and the compression ratio are set in this way, and an image capture and recording operation is executed, as a result, captured image data with a data size that is uniquely determined in accordance with the picture size and the compression ratio thus set is recorded onto the memory card 40.

In FIG. 6, first, in step S201, as the initial settings on data-size-related parameters, the picture size (horizontal pixel count x vertical pixel count) is set to the maximum, and as for a plurality of levels of compression ratio that can be selected under this picture size setting, the lowest value is set. That is, the data size of captured image data that can be captured and recorded on the digital still camera 100 is set to the maximum.

In step S202 that follows, a reference data size “m” is acquired. The reference data size “m” is the data size of captured image data that is uniquely determined in accordance with the data-size-related parameters being currently set.

As mentioned above, the data size of captured image data at the time when recorded onto the memory card is determined substantially uniquely depending on the picture size and the compression ratio. However, strictly speaking, variations occur within a certain range in accordance with the complexity of a captured image or the like. Accordingly, while taking such range of variations into account, the reference data size “m” is obtained as the data size of captured image data that can be regarded as a reference.

As for the method of obtaining this reference data size “m”, for example, it may be possible to perform computation of a predetermined function by using the picture size, that is, the pixel count expressed as the horizontal pixel count×the vertical pixel count, and the value of compression ratio which are currently set. Alternatively, it may be possible to prepare a reference data size, which is found in advance from the relationship between the image size and the compression ratio that can be set by the digital still camera 100, in the form of table information in advance, and acquire the reference data size “m” corresponding to the matrix of the image size and compression ratio currently set, from this table information.

In step S203 that follows, an actual possible image capture and record count “d” is acquired.

The actual possible image capture and record count “d” refers to the maximum number of pieces of captured image data having the reference data size “m” acquired in step S202 mentioned above that can be recorded in the free capacity M acquired in step S102 mentioned above. Thus, the actual possible image capture and record count “d” can be found as a quotient (which is herein assumed to be an integer value with its fractional portion dropped) obtained by the following computation.

d=M/m (Equation 2)

Subsequently, in step S204, with respect to the possible additional record count “c”, and the actual possible image capture and record count “d” acquired in step S203 mentioned above, it is determined whether or not the following holds.

c≦d (Equation 3)

Since a positive determination result has been obtained in step S107 in FIG. 5 mentioned above before this step S204 is reached, the possible additional record count “c” at this point is a natural number of 1 or more.

Now, first, if (Equation 3) mentioned above does not hold, that is, the relationship c>d holds and hence a negative determination result is obtained, two cases are considered with respect to the relationship between the free capacity on the memory card and the captured image data of the reference data size “m” currently set.

The first case is one in which, as the quotient based on (Equation 2) above, d=0 is obtained as the computation result, and hence c>d holds. This computation result is obtained when the reference data size “m” is larger than the free capacity M, which corresponds to a state in which there is not enough free capacity M for recording one piece of captured image data with the current picture size and compression ratio. Further, the second case corresponds to a state in which “d” takes an integer value, and the relationship c>d holds. This corresponds to a state in which, although the free capacity M allows recording of at least one piece of captured image data, the current reference data size “m” is still too large, and if this is unchanged as it is, the number of pieces of captured image data equal to the possible additional record count “c” cannot be recorded.

Either of the above-mentioned two cases indicates that the current reference data size “m” is too large. Accordingly, if a negative determination result is obtained in step S204 as described above, the settings on the data-size-related parameters are changed in the manner as described below so that the reference data size “m” that is one level smaller is obtained.

To this end, first, in step S205, it is determined whether or not the compression ratio that is currently set corresponds to the highest value in the case of the picture size that is currently set as well. As previously described, the compression ratio can be changed in a predetermined number of levels for each level of picture size. It is stated here for confirmation that the compression ratio corresponds to, for example, a value obtained by dividing the data size after compression by the data size before compression. The higher the compression ratio, the smaller the data size. Further, as the compression ratio becomes higher, the reversibility becomes lower and the playback image quality deteriorates.

If the result of the determination in step S205 is negative, that is, if the compression ratio is still not at the highest value, this means that there is some room for increasing the compression ratio to achieve reduced data size while keeping the current picture size. Accordingly, in this case, in step S206, the settings are changed only with respect to the compression ratio in such a way that the compression ratio becomes one level higher than before, under the current picture size setting.

Then, the process returns to step S202, where the reference data size “m” is acquired again.

If a positive determination result is obtained in step S205, this means that the highest compression ratio under the current picture size setting is set, and it is no longer possible to change only the compression ratio to be higher while keeping the picture size as it is. In this case, the process proceeds to step S207.

In step S207, first, it is determined whether or not the currently set picture size is the smallest value within a variable range of picture sizes that can be set by the digital still camera 100.

Here, first, if a negative determination result is obtained, this means that it is still possible to change the picture size to a smaller picture size. Accordingly, in this case, in step S208, a picture size that is one level smaller than before is set. As for the compression ratio, in accordance with the one-level smaller picture size that is newly set, the smallest compression ratio under this newly set picture size is set. That is, when a picture size is set anew, the loop process of steps S202 to S206 can be started with a compression ratio that makes the data size largest under the condition of the set picture size. After step S208, the process returns to step S202.

In the loop process of steps S202 to S208 mentioned above, the picture size and the compression ratio as the data-size-related parameters are changed until the reference data size “m” that makes it possible to obtain a positive determination result in step S204 is obtained. In this regard, first, the compression ratio is raised under the same picture size setting, and only after it becomes impossible to raise the compression ratio any further, then the picture size is changed. The reason why priority is placed on changing the compression ratio first is because the amount of change in the reference data size “m” is smaller when changing the compression ratio under the same picture size setting than when changing the picture size in a stepwise manner. That is, by the loop process from steps S202 to S208, the reference data size “m” is sequentially reduced stepwise so that a positive determination result is obtained in step S204.

Assuming that the algorithm for the above-mentioned loop process includes a parameter changing operation that does not reduce the reference data size “m” sequentially in a stepwise manner but reduces the reference data size “m” by more than two levels at a time, a case may arise in which a positive determination result is obtained in step S204 when the picture size and the compression ratio are set at values corresponding to the reference data size “m” that is smaller than what is actually the optimum value. As a result, it is not possible to perform recording the rest of the captured image data by making the maximum use of the free capacity.

If a positive determination result is obtained in step S207, this means that as the data-size-related parameters at this point, the picture size is at its smallest, and the compression ratio is set at the highest value under this picture size setting. In this state, although the actual possible image capture and record count “d” has yet reached the possible additional record count “b”, the actual possible image capture and record count “d” cannot be increased any more by making the reference data size “m” smaller. Accordingly, in this case, in step S209, a process for outputting an error message is executed. As for the error message at this time, for example, at least an indication stating that “the number of pieces of captured image data up to the maximum record count cannot be recorded onto the memory card” is displayed on the display screen section 5 for notification to the user. In this case, when the image capture mode is entered in this state, there are several possible ways for the digital still camera 100 to handle this situation. For example, one such way to handle this situation is to treat the memory card as an ordinary memory card.

Then, for example, if c≦d is satisfied and hence a positive determination result is obtained in step S204 at some point during the execution of the loop process from steps S202 to S208, the process proceeds to step S210.

It is stated here for confirmation that since the reference data size “m” changes stepwise by a given amount at a time through the loop process from steps S202 to S208, there is a possibility that c<d is satisfied and a positive determination result is obtained in step S204. Further, there is also a possibility that the actual possible image capture and record count “d” found by the initial parameter settings made in step S201 becomes larger than the possible additional record count “c” from the beginning. In this case as well, a positive determination result is obtained in step S204.

In step S210, a setting is made to prohibit any further user's operation to change the picture size and the compression ratio as data-size-related parameters. For example, a flag indicating permission/prohibition of user's operation to change the picture size and the compression ratio is defined, and a value indicating prohibition is set with respect to this flag.

By executing the above-mentioned process, in a case where a maximum-record-count-specified memory card is loaded, data-size-related parameters (picture size and compression ratio) that allow captured image data to be recorded up to the maximum record count by making the maximum use of the free capacity at that time are automatically set.

Then, for example, when an image capture and recording operation is performed as the image capture mode, the digital still camera 100 generates captured image data in accordance with the picture size and the compression ratio according to the data-size-related parameters that are automatically set as mentioned above, and records the generated captured image data onto the memory card (maximum-record-count-specified memory card) 40.

Further, in this embodiment, a user's operation to change the picture size and the compression ratio are prohibited in step S210 in FIG. 6. Thus, even when the user attempts to change the picture size and the compression ratio during the image capture mode, for example, a GUI is formed so that such a change is disabled. For example, the control section 27 (CPU) references the flag described above with reference to step S210, and forms the above-mentioned GUI if this flag indicates prohibition.

The reason why settings on the data-size-related parameters are disabled in this way is that the use of a maximum-record-count-specified memory card is essentially linked to the desire or purpose of being able to use a digital still camera with ease without having to be aware of the number of pictures that can be captured which changes depending on the relationship between the recording capacity of the memory card and the size of captured image data. However, in consideration of those users who have a fairly good knowledge of digital equipment or the like, a configuration may be provided such that when a given operation is performed, the above-mentioned prohibition is cancelled, and settings can be made to the data-size-related parameters.

As for the deletion of captured image data recorded onto a maximum-record-count-specified memory card once, it may be possible to both disable and allow such an operation. If a delete operation is disabled, the maximum-record-count-specified memory card can be used in much the same way a film is used, which reduces confusion for users who are not familiar with digital equipment. However, a digital still camera is essentially digital equipment, and as such one of its advantages is the ease of a delete operation. If emphasis is to be placed on this point, then it would be appropriate to allow a delete operation.

Since data-size-related parameters are set each time a mounting process is executed in this embodiment, it is possible that prior to the mounting process, image capture and recording may have been performed under data-size-related parameter settings different from those of the present time. Then, in the case of a configuration in which a delete operation of captured image data is allowed, if, for example, deletion of a captured image that has already been recorded prior to the current mounting process is also allowed, a situation may arise where as a result of a delete operation, a corresponding free capacity is newly obtained. In such a case, the procedure from step S102 onwards in FIG. 5 is preferably executed again so that data-size-related parameters that provide a larger data size can be reset.

The digital still camera 100 according to this embodiment sets data-size-related parameters in such a way that captured image data can be recorded by making the maximum use of the free capacity M on a maximum-record-count-specified memory card. Further, this setting of data-size-related parameters is performed at the timing of a mounting process, that is, whenever a memory card loaded in the digital still camera 100 may have been replaced.

This means that even in the case of a maximum-record-count-specified memory card onto which captured image data is previously recorded by another digital still camera, at the time when the memory card is loaded into the digital still camera 100 anew, appropriate data-size-related parameters can be set in accordance with the free capacity available at that time, without being affected by the previous picture size and compression ratio of captured image data. That is, the digital still camera 100 according to this embodiment can execute a proper image capture and recording operation at all times irrespective of whether the maximum-record-count-specified memory card being currently loaded is an unused one or not.

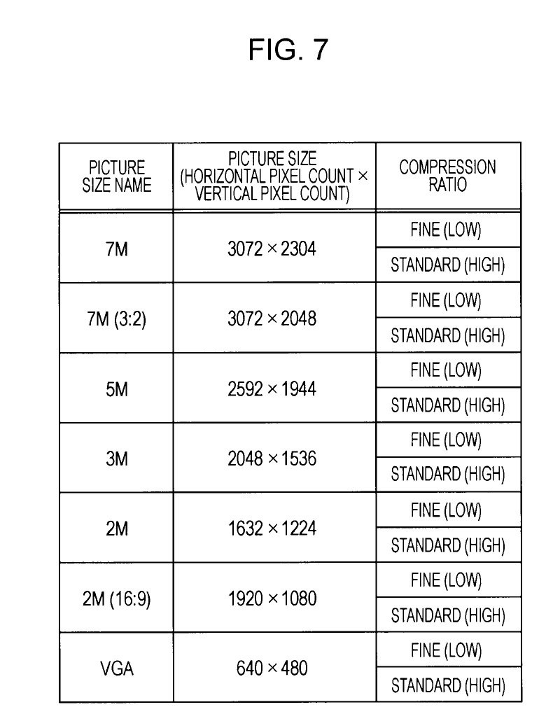

Now, by way of reference, FIG. 7 shows a specific example of different levels of data-size-related parameters (picture size and compression ratio) that are assumed to be actually set for the digital still camera 100 according to this embodiment.

First, in this case, seven levels of picture size parameter are provided, which are respectively given the following names, starting from the largest picture size to the smallest picture size: “7M”, “7M (3:2)”, “5M”, “3M”, “2M”, “2M (16:9), and “VGA (Video Graphic Array)”.

As shown in FIG. 7, the actual picture sizes (horizontal pixel count×vertical pixel count: resolution) corresponding to the respective image size names are 7M; (3072×2304), 7M (3:2); (3072×2048), 5M; (3592×1944), 3M; (2048×1536), 2M; (1632×1224), 2M (16:9); (1920×1080), and VGA; (640×480), respectively.

Two levels of compression ratio, respectively given the names of “FINE” and “STANDARD”, are provided for each of the seven levels of picture size mentioned above. Predetermined compression ratios that differ from each other actually correspond to “FINE” and “STANDARD”. The compression ratio is lower in the case of “FINE” than in the case of “STANDARD”. That is, the resulting data size is larger and the playback image quality is better in the case of “FINE” than in the case of “STANDARD”. It should be noted that the actual values of compression ratio corresponding to “FINE” and “STANDARD” may be the same among the seven levels of picture size, or may differ in accordance with each picture size.

As can be appreciated from the above discussion, in the specific example shown in FIG. 7, first, seven levels are set for the picture size parameter, and then two levels of compression ratio are set for each picture size. Thus, the reference data size “m” sequentially decreases through the following 14 levels from Levels 1 to 14 based on the combination of picture size and compression ratio (picture size+compression ratio name).

Level 1. 7M; (3072×2304)+FINE

Level 2. 7M; (3072×2304)+STANDARD

Level 3. 7M (3:2); (3072×2048)+FINE

Level 4. 7M (3:2); (3072×2048)+STANDARD

Level 5. 5M; (3592×1944)+FINE

Level 6. 5M; (3592×1944)+STANDARD

Level 7. 3M; (2048×1536)+FINE

Level 8. 3M; (2048×1536)+STANDARD

Level 9. 2M; (1632×1224)+FINE

Level 10. 2M; (1632×1224)+STANDARD

Level 11. 2M (16:9); (1920×1080)+FINE

Level 12. 2M (16:9); (1920×1080)+STANDARD

Level 13. VGA; (640×480)+FINE

Level 14. VGA; (640×480)+STANDARD

Assuming that the data-size-related parameters shown in FIG. 7 are actually set, the flow of changes made to the picture size and the compression ratio when the processing procedure shown in FIG. 6 is executed is as described below.

First, in step S201, the initial parameters are set to Level 1 (7M; (3072×2304)+FINE), which represents a combination of picture size and compression ratio that makes the reference data size “m” largest. For example, if a positive determination result is not obtained in step S204 with the initial parameters, when a negative determination result is further obtained in step S205 and step S206 is executed, Level 2 (7M; (3072×2304)+STANDARD) is set for the data-size-related parameters. If a positive determination result is still not obtained in step S204 with the reference data size “m” obtained from this parameter combination, at this time, a positive determination result is obtained in step S205 first, and then a negative determination result is obtained in step S207, and thus in step S208, 7M (3:2); (3072×2048) that is a picture size one level smaller than before is set, and the compression ratio is reset to FINE corresponding to the lowest value of compression ratio. That is, the picture size and the compression ratio according to Level 3 are set.

Thereafter, through the same procedure, the combination of picture size and compression ratio is sequentially changed by one level at a time subsequently from Level 4 to Level 14, and once a positive determination result is obtained in step S204, the data-size-related parameters (picture size and compression ratio) that are set at that time become the picture size and compression ratio that are actually effective during the image capture mode.

It should be noted that as previously stated, the breakdown of the variable contents of the picture size and compression ratio as data-size-related parameters shown in FIG. 7 mentioned above are merely one specific example, and the present invention is also applicable to a case where the variable contents of the picture size and compression ratio are other than those mentioned above.

As previously stated, there are diverse kinds of data that can be recorded on a memory card, depending on the intended usage or the like of the digital equipment used. Thus, when the maximum-record-count-specified memory card according to this embodiment is loaded into, for example, an apparatus other than the digital still camera 100 according to this embodiment, data files containing data other than still images, for example, audio data files or the like can be recorded. One major advantage of the procedure shown in the flowchart of FIG. 6 is that even when, for example, data files other than those containing captured still image data are recorded, the data size of captured images can be automatically set so that the number of pictures of still image data indicated by the maximum record count information can be recorded.

However, if recorded data files containing data other than captured still image data takes up too large a portion of the recordable capacity, the free capacity becomes too small, which makes it highly possible that recording of still image data corresponding to the number of pictures indicated by the maximum record count information cannot be guaranteed. Accordingly, to guarantee that captured still image data corresponding to the number of pictures indicated by the maximum record count information can be recorded with reliability, it may be possible to provide a maximum-record-count-specified memory card that can secure a recording area dedicated to captured still image data (maximum-record-count-guaranteed memory card).

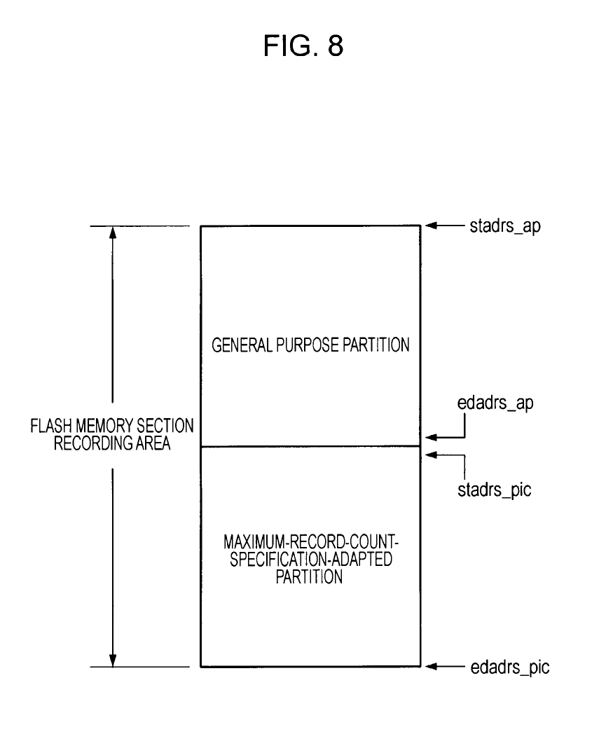

FIG. 8 shows the contents of the recording area as the flash memory section 41 included in the above-mentioned maximum-record-count-guaranteed memory card at initialization.

As shown in FIG. 8, in the maximum-record-count-guaranteed memory card, the recording area as the flash memory section 41 is split into at least two partitions of a general purpose partition and a maximum-record-count-specification-adapted partition. It should be noted that the capacity of each of these partitions may be set to a value that is considered to be appropriate in accordance with the actual use conditions.

The general purpose partition serves as a partition into which written file data can be recorded without any particular restriction as to the type of file data, in the same way as ordinary general purpose memory cards.

In contrast, the maximum-record-count-specification-adapted partition serves as a dedicated area into which an apparatus that supports the maximum record count information recorded on the maximum-record-count-specified memory card writes captured still image data for recording, like the digital still camera 100 according to this embodiment.

For example, in a case where the maximum-record-count-guaranteed memory card shown in FIG. 8 is loaded into an ordinary information processing apparatus that does not support the maximum-record-count-specified memory card, as seen from this standard information processing apparatus, only the general purpose partition appears to be an accessible area. That is, the ordinary information processing apparatus can recognize only the recording area corresponding to the general purpose partition from the start address stadrs_ap to the end address edadrs_ap as an accessible area, and cannot recognize the recording area corresponding to the maximum-record-count-specification-adapted partition from the start address stadrs_pic to the end address edadrs_pic as an accessible area. Thus, an apparatus that does not support the maximum-record-count-specified memory card can perform recording and playback of various kinds of file data into and from the recording area of the general purpose partition in a normal manner.

On the other hand, in a case where the maximum-record-count-guaranteed memory card is loaded into the digital still camera 1 according to this embodiment which is an apparatus that supports the maximum record count information recorded on the maximum-record-count-specified memory card, the digital still camera 100 recognizes the maximum-record-count-specification-adapted partition (stadrs_pic to eadrs_pic) as the recording area into which captured still image data is to be recorded. Then, the picture size and compression size of captured still image data are set in the manner as described in the foregoing to perform image capture and recording.

To this end, for example, in addition to the maximum record count information, dedicated partition address specifying information indicating the address of the maximum-record-count-specification-adapted partition is also stored in the ROM area 42a of the maximum-record-count-specified memory card. When executing a mounting process with respect to the memory card 40, an apparatus that supports the maximum record count information (the digital still camera 100) attempts to read maximum record count information in accordance with step S103 in FIG. 5, for example, and if the maximum record count information can be successfully read (if the maximum record count information is stored), the apparatus also attempts to read dedicated partition address specifying information. At this time, if reading of the dedicated partition address specifying information succeeds, this means that of various maximum-record-count-specified memory cards, the memory card in question is the maximum-record-count-guaranteed memory card having the maximum-record-count-specification-adapted partition. Accordingly, if dedicated partition address specifying information is successfully read, the digital still camera 100 executes the mounting process again so as to recognize the maximum-record-count-specification-adapted partition as the partition for recording captured still image data, for example. Thus, subsequently, it is possible for the digital still camera 100 to record captured still image data into the maximum-record-count-specification-adapted partition.

In the above-mentioned embodiment, the recording medium on which captured image data is recorded is a memory card that complies with a predetermined standard. That is, as for the type of recording medium, at the present time, a flash memory as a type of semiconductor recording element is employed. However, for example, if commercially applicable semiconductor recording elements other than the flash memory are developed and become common in the future, these semiconductor recording elements may be employed as well. Further, other types of recording medium other than the semiconductor recording element, including disc-shaped recording medium such as an optical disc-shaped recording medium or magnetic disc-shaped recording medium may be used as well.

In this regard, in the above-mentioned embodiment, the flash memory used as the memory card 40 that is a recording medium (recording medium apparatus) on which captured image data is recorded is classified as that of a non-volatile rewritable type as is known in the art. Therefore, the foregoing description is based on the assumption that the flash memory 40 allows such operations as rewriting and erasure.

However, as can be appreciated from the foregoing description, it can be said that the maximum-record-count-specified memory card described in this embodiment is designed to allow selection at purchase and use at image capture in much the same way as the photographic films in the past. With this in mind, assuming specifications that prohibit deletion of captured image data that has already been recorded, it can be said that as the maximum-record-count-specified memory, a recording medium that is not rewritable, for example, a write-once type recording medium can be also used without any problem.

At the present time, known examples of such a write-once type, optical disc-shaped recording medium include a CD-R, a DVD-R, and the like. Further, a memory card or the like including a flash memory can be also provided as a non-rewritable, write-once type recording medium by changing the internal memory control configuration.

While in the above-mentioned embodiment a digital still camera has been described as an example of the image capturing apparatus according to an embodiment of the present invention, the present invention is applicable to a broad range of electronic equipment endowed with a still image capture function such as a video camera apparatus endowed with a function of recording captured images as still images, a mobile telephone apparatus endowed with a still image capture function, for example.

It should be understood by those skilled in the art that various modifications, combinations, sub-combinations and alterations may occur depending on design requirements and other factors insofar as they are within the scope of the appended claims or the equivalents thereof.

What is claimed is:

1. An image capturing apparatus comprising:
captured still image data generating means for converting captured light into an electrical signal and generating captured still image data representing a still image from the electrical signal;
recording means for recording the captured still image data onto a recording medium;
free-capacity recognizing means for recognizing a free capacity on the recording medium;
prescribed-maximum-possible-record-count calculating means for calculating a prescribed maximum possible record count indicating the maximum number of pieces of captured still image data that are allowed to be recorded, in accordance with the free capacity; and
parameter determining means for determining a parameter to be set on the captured still image data generating means and used for adjusting a data size of the captured still image data,
wherein the parameter determining means determines the parameter such that a data size of the captured still image data is adjusted to a data size that allows captured still image data equal to the prescribed maximum possible record count to be recorded onto the recording medium while making maximum use of the free capacity.

2. The image capturing apparatus according to claim 1, wherein:
the prescribed-maximum-possible-record-count calculating means further includes
prescribed-maximum-allowed-record-count recognizing means for recognizing a prescribed maximum allowed record count with respect to the recording medium on the basis of prescribed maximum allowed record count information, which is recorded on the recording medium in advance and indicates the prescribed maximum allowed record count representing the maximum number of pieces of captured still image data that are allowed to be recorded onto the recording medium, and
recorded count information recognizing means for recognizing a recorded count indicating the number of pieces of captured image data that have already been recorded on the recording medium; and
the prescribed maximum possible record count is calculated using the prescribed maximum allowed record count and the recorded count.

3. The image capturing apparatus according to claim 1, wherein:
the parameter determining means executes a data-size sequentially changing control of changing a data size of the captured still image data so as to become sequentially smaller within a range from maximum to minimum; and
the parameter determining means determines the parameter by changing a data size of the captured still image data so as to become sequentially smaller by the data-size sequentially changing control, and terminating the data-size sequentially changing control upon obtaining a data size of the captured still image data that allows the captured still image data equal to the prescribed maximum possible record count to be recorded onto the recording medium so as to make maximum use of the free capacity.

4. The image capturing apparatus according to claim 3, wherein:
the parameter determining means changes a compression ratio for the captured still image data as the parameter in executing the data-size sequentially changing control.

5. The image capturing apparatus according to claim 3, wherein:
the parameter determining means changes a picture size of the captured still image data as the parameter in executing the data-size sequentially changing control.

6. The image capturing apparatus according to claim 3, wherein:
the parameter to be changed for the data-size sequentially changing control includes a compression ratio for the captured still image data and a picture size of the captured still image data; and
as the data-size sequentially changing control, under a condition in which one picture size is being set, the parameter determining means sequentially changes a compression ratio at the set picture size to become higher by one level at a time, and at the next level after the highest compression ratio is set, the parameter determining means executes changing to a one-level smaller picture size.

7. The image capturing apparatus according to claim 6, wherein:
when the parameter determining means executes changing to a one-level smaller picture size as the data-size sequentially changing control, the parameter determining means executes changing to the lowest compression ratio among compression ratios at the changed picture size.

8. The image capturing apparatus according to claim 2, wherein:
the prescribed-maximum-possible-record-count calculating means calculates the prescribed maximum possible record count on the basis of the prescribed maximum allowed record count, only when the prescribed maximum record count is recorded on the recording medium.

9. An image capturing method comprising the steps of:
converting captured light into an electrical signal, and generating captured still image data representing a still image from the electrical signal;
recording the captured still image data onto a recording medium;
recognizing a free capacity on the recording medium;
calculating a prescribed maximum possible record count indicating the maximum number of pieces of captured still image data that are allowed to be recorded, in accordance with the free capacity; and
determining a parameter used for adjusting a data size of the captured still image data,
wherein in the determining step, the parameter is determined such that a data size of the captured still image data is adjusted to a data size that allows captured still image data equal to the prescribed maximum possible record count to be recorded onto the recording medium while making maximum use of the free capacity.

10. An image capturing apparatus comprising:
a captured still image data generating section that converts captured light into an electrical signal and generating captured still image data representing a still image from the electrical signal;
a recording section that records the captured still image data onto a recording medium;
a free-capacity recognizing section that recognizes a free capacity on the recording medium;
a prescribed-maximum-possible-record-count calculating section that calculates a prescribed maximum possible record count indicating the maximum number of pieces of captured still image data that are allowed to be recorded, in accordance with the free capacity; and
a parameter determining section that determines a parameter to be set on the captured still image data generating section and used for adjusting a data size of the captured still image data,
wherein the parameter determining section determines the parameter such that a data size of the captured still image data is adjusted to a data size that allows captured still image data equal to the prescribed maximum possible record count to be recorded onto the recording medium while making maximum use of the free capacity.
